(19) United States
(12) Patent Application Publication
(10) Pub. No.: US 2016/0049839 A1
(43) Pub. Date: Feb. 18, 2016

(54) DEVICE AND PROCESS FOR THE GENERATION OF ELECTRICAL ENERGY

(71) Applicant: ARION TECNOLOGIA BRASIL-GESTÃO DE ATIVOS S/A, Aldeota, Fortaleza - CE (BR)

(72) Inventors: Gerson SILVA PAIVA, Rio de Janeìro - RJ (BR); Sebastião FLORENTINO DA SILVA, Rio de Janeíro - RJ (BR)

(73) Assignee: ARION TECHNOLOGIA BRASIL-GESTÃO DE ATIVOS S/A, Fortaleza - CE (BR)

(21) Appl. No.: 14/781,678

(22) PCT Filed: Apr. 7, 2014
(86) PCT No.: PCT/BR2014/000112

§ 371 Date: Oct. 1, 2015

(30) Foreign Application Priority Data
Apr. 5, 2013 (BR) PCT/BR2013/000107

(51) Int. Cl. H02K 3/28; G21H 7/00; H02K 11/00

(52) U.S. Cl. CPC H02K 3/28; H02K 11/0094; H02K 11/0068; G21H 7/00

(57) ABSTRACT

A muonic electromagnetic generator for generating electrical energy is provided and includes a generator that is connectable to at least one source of electric energy with a lower power than the power generated by the generator. The generator includes at least one outer electric coil, at least one inner electric coil, situated substantially inside the outer electric coil, and an oscillator. The oscillator is connected between the source of electrical energy and the outer electric coil. When the outer electric coil is connected to a source of electric energy via an oscillator that was previously tuned to emit a frequency corresponding to a certain fraction specific to the Compton frequency of a muon, the muonic energy is absorbed by an inner electric coil, and this energy can be used to feed any external load. This muonic energy can be significantly greater than the power of the source of energy

### DEVICE AND PROCESS FOR THE GENERATION OF ELECTRICAL ENERGY

The present invention refers to a device and a process for the generation of electrical energy by way of the decay of muons (μ), originating from cosmic particles, called pions.

The muon is an elementary particle called “a second generation partner” of the electron with a mass approximately 200 times greater than an electron, although with the same spin (½) and the same charge. It was discovered in 1937 in cosmic radiation. This particle is not influenced by strong interactions and only participates in weak and electromagnetic interactions. The muon is very unstable and has a life time of 2·10⁻⁶ and normally decays in an electron, a μ-neutrino and an electron-neutrino.

As it is known so far, photonic generators exist, called solar cells, capable of capturing light particles called photons (solar panels) from the sun, and transforming them into electric energy; see, for example, the US patent document No. 20090127773. However, this technology suffers from meteorological restrictions as it is dependent on sunlight thus limiting the industrial applicability. On the other hand, there exist devices called muon detectors; see, for example, the US patent document No. 20090101824. These devices have the function of detecting or counting the number of muons arising from cosmic rays that naturally reach the earth's surface, not taking advantage of them to produce electrical energy. However, these particles have very high energy, typically from 3 to 4 GeV. This fact is mentioned in the Brazilian Journal of Physics Teaching (“Revista Brasileira de Ensino de Fisica”), volume 29, No. 4, pages 585-591 (2007) in a didactic article about a simple experiment of muon detection and a discussion about the lifetime of the particle. However, this article makes no mention of a possible extraction of energy from the muons.

Reference is also made to the U.S. Pat. No. 7,863,751, which describes a detector of muons. However, as the title of this patent says, it only refers to the detector of muons, and not a captivator of energy inherent to the muons.

A first application relating to this invention was filed on 5 Oct. 2012 with the number PCT/BR2012/000382.

Thus, a main object of the present invention is to offer a device that can utilize the inherent energy of muons to produce energy.

A further object of the present invention is to produce energy independent of meteorological conditions.

Another object of the present invention is to utilize a source of energy that does not pollute the environment.

Very surprisingly, these objectives were achieved through a device that extracts energy inherent to muons and transforms it into electrical energy, according to the features defined in claim 1.

The order of magnitude of muon flux at the earth's surface is about 10⁻⁴/m²·s and therefore, the flux of muons is negligible. For example, to achieve a power of 760 kW (equivalent to 4, 7·10¹⁵ eV/s), considering that each muon has an energy of 4 GeV, it would take a flow of the order of 10¹⁵ muons/s. To compensate for said negligible flow, it would be necessary to increase the capture area of muons with coils of areas equivalent to the area of several cities, which would be totally inviable. Nevertheless, and very surprisingly, the device according to the present invention can capture a sufficient number of muons to enable a realistic extraction of muonic energy from the air and is highly economical in an area of less than half a square meter. Without being limited to a probable physics theory, it is believed that the explanation is as follows:

A magnet has “closed” and “open” field lines, which form an angle Θ between them tending to zero. Likewise the magnetic field from the primary coil of the muonic generator according to the invention also has both types of magnetic lines. Thus the “open” field lines propagate to high altitudes including the region of the formation of muons, at an altitude of 10 kilometers, forming a magnetic funnel whose top “opening” can have a radius of dozens of kilometers. It is these lines that will collimate atmospheric muons into the coil of the generator of the present invention, whose diameter is for example only a few centimeters. Thus, the magnetic field of the coil acts as a muon drain, which is oscillating in time. This frequency of oscillation of the field has a wavelength λ_{B} that is a fraction multiple of the Compton wavelength of the muon λ_{C} (λ_{B}=n·λ_{C}=n·5, 88×10⁻²³ m) so that the energy of the magnetic field used in the captation process is reduced as much as possible and is selective of muons only. The whole process above applies in cases in which the coil of the muonic generator presents its axis horizontally, vertically or at any angle between these.

We calculated the area of detection of atmospheric muons required for an output power of 760 kW in a muonic generator. It is known that on the surface of the earth there are on average 10⁴ muons per square meter per second. At the top of the troposphere, at an altitude of about 10 km, the rate of muons is ten times greater than at the earth's surface. Accordingly, at an altitude of 10 km, the rate of muons is φ=10⁵ muons·m⁻²·s⁻¹. The power output of the muonic generator is P=760 000 W or 4·10²⁴ eV s⁻¹=4·10¹⁵ GeV s⁻¹. Considering that the energy of each muon is Eᵢ=4 GeV and at the top of the troposphere, where they are captured by the “magnetic cone”, the flow is φ=10⁵ muons·m⁻²·s⁻¹, then the total energy is

$$E = {\sum }_{i = 1}^{n} {E}_{i} Φ \qquad ( 1 )$$

Inserting the values in Equation 1 we get E=4×10⁵ GeV·m⁻²·s⁻¹.

For the muonic generator to produce an output power of Eₛ=4·10¹⁵ GeV per second the following area will be needed

$$A = {{E}_{s} ( {\sum }_{i = 1}^{n} {E}_{i} Φ )}^{- 1} \qquad ( 2 )$$

A=10⁴ km². In other words, the radius of the “mouth” of the magnetic cone at an altitude of 10 km should be R≈50 km.

Every muon can be captured by an oscillator tuned to the frequency of wave function. Thus, a muonic coil is capable of capturing and concentrating (converging, directing) into itself this flow of atmospheric muons in particle form.

It is known that electrical power can be expressed by the following relationship:

P=U·i

In which: P=electrical power (kW), U=tension (V) and i =electric current (A).

Table 1 below presents results obtained from tests carried out by means of the process and device (FIG. 1) subject of this invention patent.

TABLE 1

| Test #1 | Input | Output |
|---|---|---|
| Tension (V) | 110 | 40 000 |
| Current (A) | 19 | 19 |
| Electrical Power (kW) | 2 | 760 |

| | |
|---|---|
| COP | 380 |

It can be observed by way of the coefficient of performance (COP)—defined as the ratio between output power and input power of the muonic electromagnetic generator—that with a little input power can transform the muons coming from cosmic rays into large quantities of electrical energy, without compromising the environment or emitting radiation.

The voltage output from the muonic generator follows a function of 4 variables:

V=F(f, D, N, L);

where f is the frequency of the oscillator, D is the diameter of the coil, N is the number of turns of the coil and L is the length of the coil. The atmospheric muons can penetrate about 1 km in the ground and 2 km in sea water. Furthermore, they only form in altitudes of less than 12 km. Therefore, these distances are the limit of applicability (functionality) of a muonic generator. On the other hand, the concentration of muons at 12 km is about 10 times their concentration at the earth's surface. Thus, stationary generators atop high mountains are an interesting option in order to produce electrical energy. A magnetic anomaly exists in the atmosphere of South America such that the concentration of cosmic rays (muons) is about three times that registered in other areas (without the anomaly). This fact can be used to achieve higher production of muonic energy in areas of magnetic anomaly. The muonic electromagnetic generator has wide industrial usage, with the purpose of generating electrical energy for general consumption (industrial, commercial and residential), automotive vehicles (ships, trains, planes, helicopters, submarines, etc) and other means of transport, among other devices that are dependent on electricity, such as hydraulic pumps, compressors, radios, telephones, etc.

### A BRIEF DESCRIPTION OF FIGURES

FIG. 1—represents the wiring diagram of the muonic electromagnetic generator with its fundamental parts.

FIG. 2—represents an electro-mechanical alternative to the muonic electromagnetic generator, with high Coefficient of performance (COP).

FIG. 3—represents the upper section (along the diameter), and the section along the axis of the coil of the muonic electromagnetic generator.

FIG. 4—represents the details of construction of a frequency inverter which converts the output voltage of the muonic electromagnetic generator in three-phase sine wave for use in any industrial load (e.g. three-phase motors)

FIG. 5—shows the coupling within the oscillator.

FIG. 6—represents the flowchart illustrating the physical process to capture and transform the decay of muons coming from cosmic rays into electrical energy through high flow of electrons coming from this decay.

### DETAILED DESCRIPTION

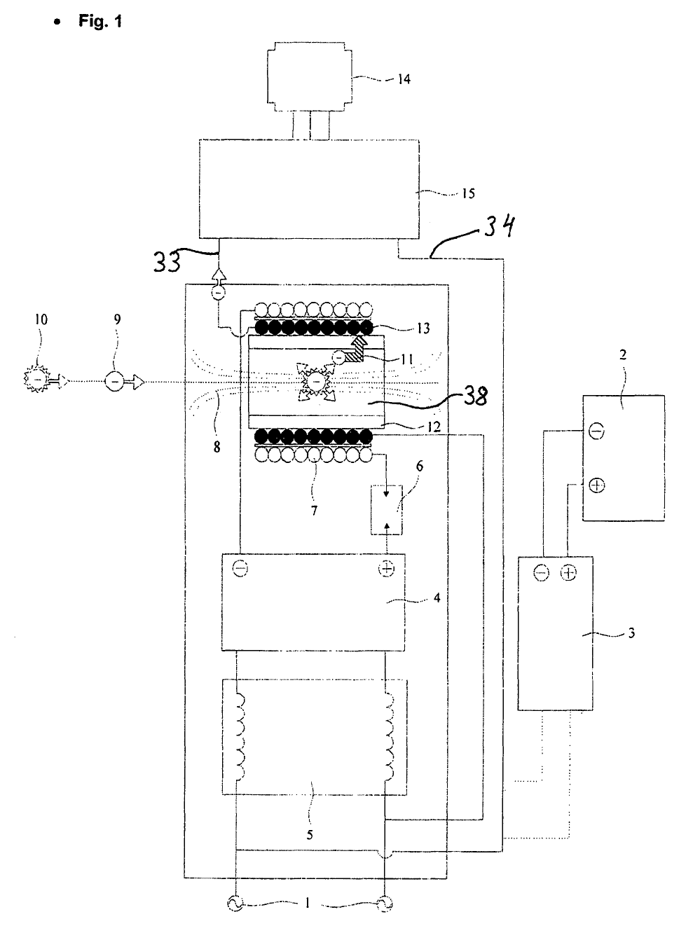

The muonic electromagnetic generator in FIG. 1 consists of a primary source 1 of electric network or a battery 2, the latter being connected to an inverter 3, which transforms the direct current from the battery into alternating current. Said source 1 or 2 feeds an oscillator 4, whose frequency is a multiple fractional of the wavelength Compton of the muon, through the protection of an inductive filter 5, while the terminals of the oscillator are connected in series with a spark-gap 6 and an external oscillating coil 7 that generates a variable oscillating magnetic field 8, with the same frequency as the oscillator, capable of attracting and concentrating the muons 9 coming from the cosmic rays 10. In the center of the said coil the muons decay (fragment) spontaneously into a great quantity of electrons 11 (a muon results in one electron) inside the central chamber 38 of the coil, till they are absorbed by the electric wires of the internal coil 13, in the form of electricity, which will feed any external load 14 through an inverter 15 of three-phase load, after having been converted to the voltage of use. The input of inverter 15 is identified with the reference 33 and the output with 34. Therefore, the muonic electrons initially have high speed and propagate in the direction of the internal coil 13 that naturally absorbs them. On this path they suffer attenuation in speed when they collide with the atoms (primarily carbon) in the core 12 of the coil. Two or more coils can be associated in series or in parallel, depending on the voltage one wants to produce, while when associated in series, the voltage tends to increase with the number of coils associated. The central chamber 38 of the coil is normally cylindrical, but can also be frusto-conical. Preferably, this chamber contains air.

As it is well known to the man skilled in the art that the electronic oscillator is an electronic circuit that produces a repetitive electronic signal, frequently a sinus wave or a square wave, without the need to apply an external signal. An oscillator is based on an amplifier circuit and a feedback loop, which induces operational instability that results in oscillation.

Various types of oscillators can be used in the present invention. An example is the Hartley oscillator (whose construction is comprised in this description by this reference), which is a type of LC oscillator, i.e., when the frequency of the signal produced is determined by a coil and a capacitor. When the circuit is switched on, the resistor polarizes the base of the transistor close to saturation, thus causing conduction. A strong current flows between the collector and the power supply, connecting the central socket through the coil. The result is that current in half of the coil induces in the other half of the same coil a current that is reapplied to the base of the transistor through the capacitor.

A power grid usually presents countless noises coming from electro-domestic appliances such as switched-mode power supplies and electric motors. This noise reaches frequencies of up to 20 kHz. These high frequency noises can interfere negatively in the functioning of the muonic generator. So the said inductive filter 5 is used to eliminate the noise of the network, thereby protecting the generator from these undesirable interferences. The construction of such an inductive filter is well known to the man skilled in the art.

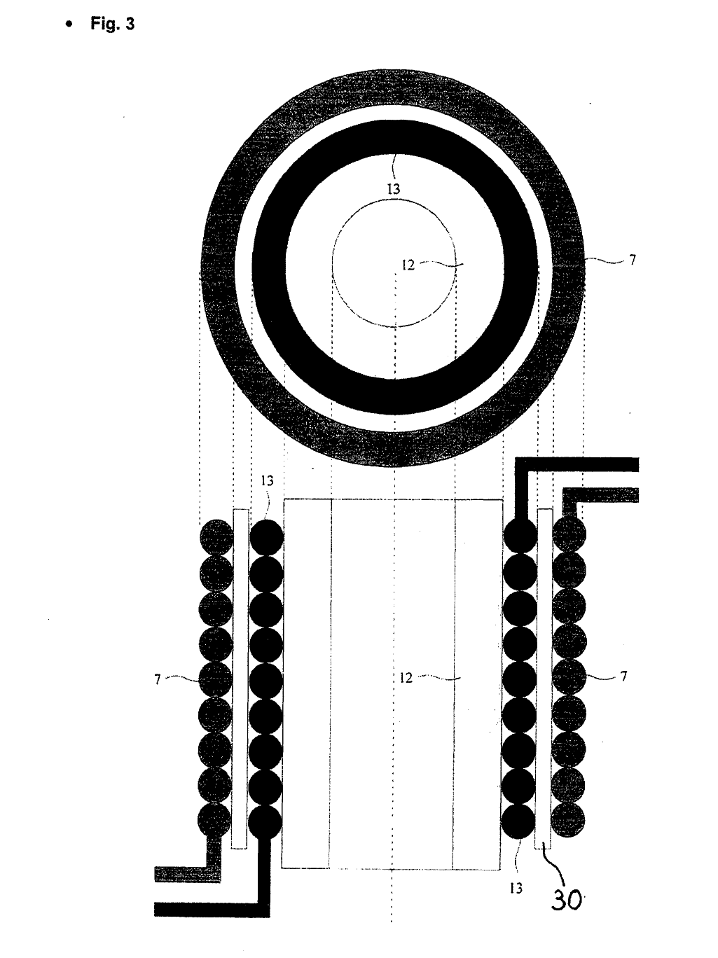

FIG. 3 shows a preferred composition of the dual coil according to the present invention. It comprises the said outer coil 7 connected to said oscillator 4 and in series with the said spark-gap 6. This spark-plug can be constituted by an industrial gas spark-gap or a spark-gap of zinc oxide, both well-known on the market. The sparking tension is already specified on the commercial component. For instance, there are spark-gaps which conduct at 300 V, 400 V, etc. In other words, the tension conducted is an intrinsic characteristic of the component.

Said spark-gap is connected in series with an oscillator 4 and with an outer coil 7 and has the purpose of amplifying the magnetic field to attract and concentrate the muons. The outer coil 7 can be made from copper wire. However, other metals or alloys of good conductivity can be used, like for example zinc, silver, gold, bronze, brass, etc. The wire includes a cylindrical layer of insulating material of the type commercialized on the market, like for example teflon, vinyl, etc. Depending on the power and current of the source, the wire can have a diameter varying between 0, 5 mm and 5 cm, depending on the current. Coil 7 can have a radius of 2 cm to 1 m, and a length of 10 cm to 10 m, depending again on the current. The outer coil 7 can have one or more layers of wire, but preferably, it has only one layer. Adjacent turns of the coil should be without spaces or spaces of less than 0,1 mm.

The inner coil 1 is preferably supported on the core or support 12, which is produced from an electrically insulating material. Therefore, this support 12 can be a tube of PVC or any other plastic material. Although less preferred, it can also be a magnetic material, such as ferrite. Normally, the inner coil 13 should be produced with a thicker wire than the outer coil 7, since it must withstand external load, from a few W to several kW. Therefore, the wire of the inner coil 13 can have a thickness varying between 1 mm and 10 cm, depending on the current of the external load. The two coils can have the same length. The inner coil 13 can have one or more layers, but preferably it should also have only one layer. Between the two coils 7 and 13 is a substantially cylindrical insulating layer 30. It can be made from a synthetic polymer, polypropylene, teflon, PVC, etc. The thickness of the insulating layer 30 can be between 0, 5 and 20 mm.

The outer radius of the core 12 is preferably from 5 cm to 1 m. The thickness of the core cylinder (=12) is from 1 to 10 cm. The core 12 has substantially the same length as the two coils 7 and 13, or for practical reasons, said core is slightly longer than the dual coil 7, 13.

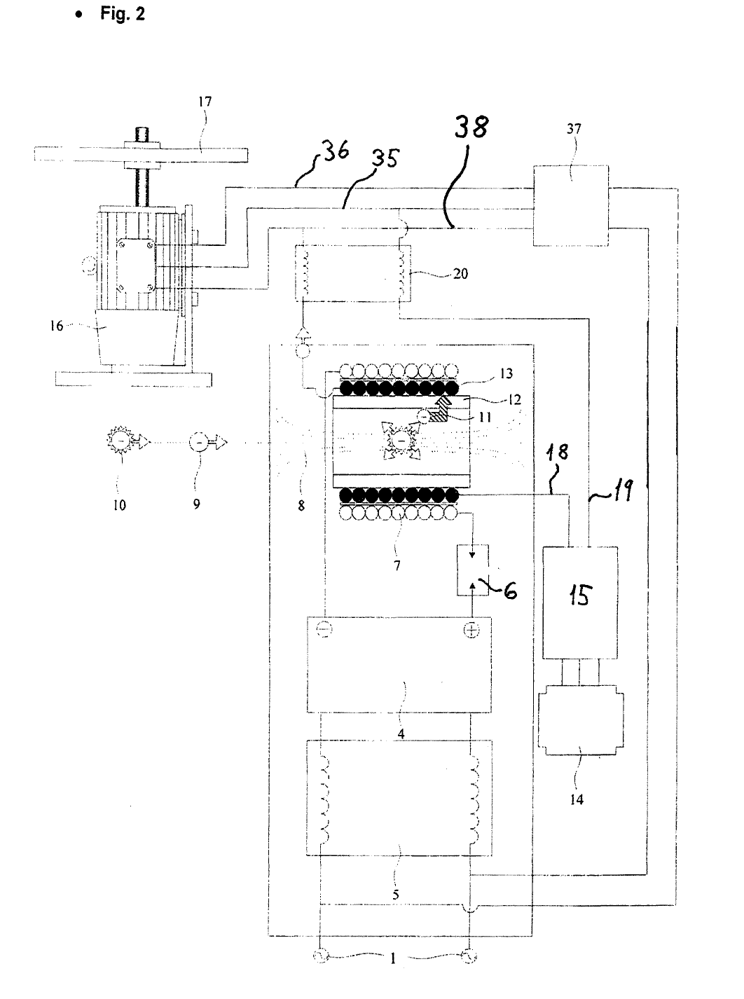

FIG. 2 shows a specific application of the muonic electromagnetic generator, with the purpose of increasing its nominal current, where at the outlet is a motor 16, the end of the axis of which lies solidary to a metal disc 17. The said motor 16 is triggered by a frequency inverter or an “ESC” (Electronic Speed Controller) 37. Both the said inverter and the ESC are well known commercial products. An inductive filter 20 protects the muonic generator from surges of the motor 16. The load 14 that is connected to the inverter 15 is fed by muonic electrons coming from coil 13 and simultaneously by electrons coming from the rotational movement of the motor-generator 16. This causes the output power 18-19 to acquire a greater power, which is conducted through the inverter 15 to the load 14, which normally (but not necessarily) is tri-phasic.

According to FIG. 2, the muonic energy of the coil 13 is carried through the inductive filter to the motor 16, where it is added to the energy produced by the rotational movement of the motor generator 16 and the disc 17 and subsequently this energy is directed by wire or line 35 and wire or line 19 to inverter 15. The wire 36 is only utilized to start motor 16. The wire 38 is the third outlet phase of the inverter 37 when the later has three phases.

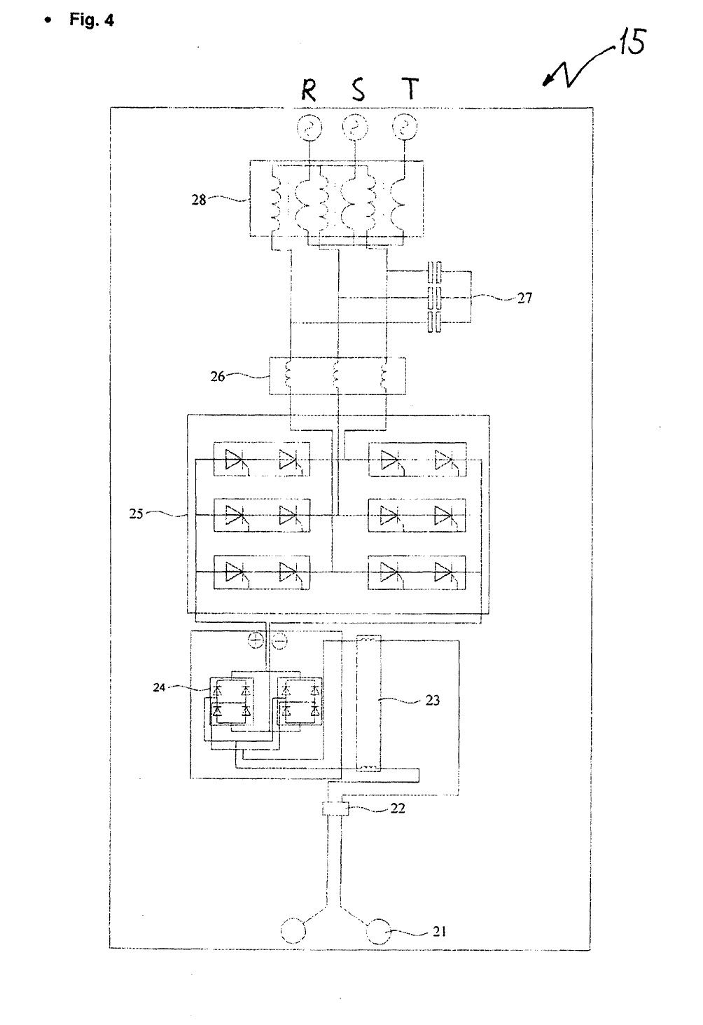

FIG. 4 shows the inverter 15 connected to the muonic electromagnetic generator by way of a pair of wires 21, wherein the inverter consists of an arrester 22, normally produced from zinc oxide (ZnO), a smoothing filter 23, rectifier bridges 24 in parallel, a high tension thyristor bridge 25, an output filter 26, three-phase capacitors 27, and a three-phase transformer 28, that reduces high tension. The three outlets of the transformer are normally called R, S and T. This unit illustrated in FIG. 4 is known per se and is usually ordered commercially.

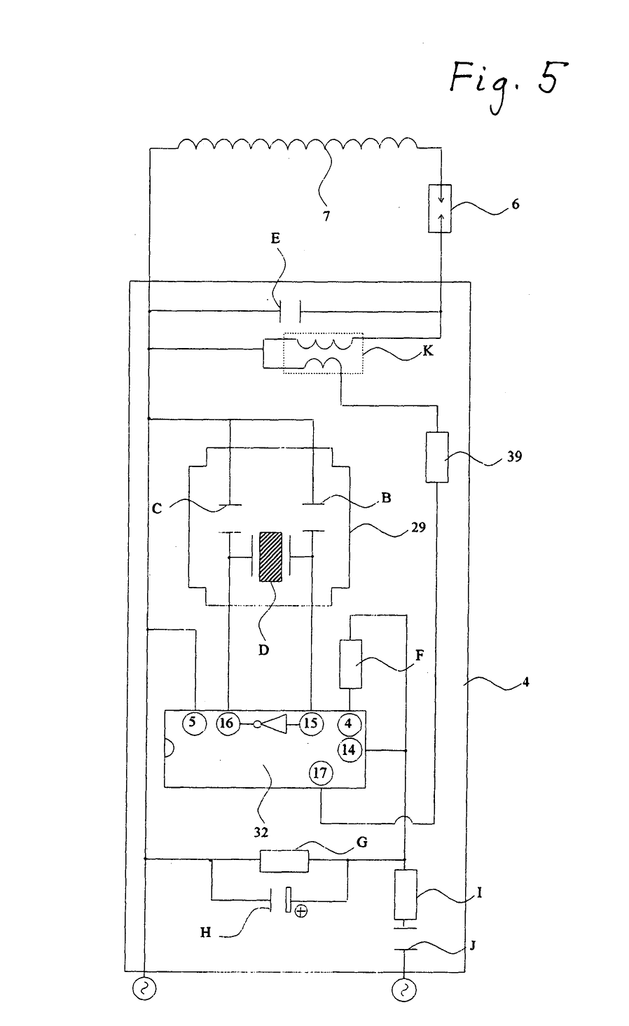

FIG. 5 shows the oscillator 4 of the muonic electromagnetic generator, which consists of an oscillator of high frequency negative resistance, formed basically of a resonant circuit 29, such as an inductive-capacitive circuit (for example, a crystal or resonant cavity), which is connected with a device 39 with negative differential resistance (for example a tunnel diode or a diode of the type “Gunn”), and a direct current polarization voltage, which is applied to the power supply feeding the oscillator, and two pre-numbered terminals of the programmable integrated circuit 32 type 16F628 are used to set the frequency of the oscillator. The two terminals to be used are identified by the standard references 15 and 16.

According to a preferred embodiment, the oscillator 4 has a structure constituted by a resonator 29, formed by an oscillating quartz crystal D and two ceramic capacitors B and C. The resonator 29 oscillates when connected to the programmable integrated circuit 32 via the terminals 15 and 16. The PIC (“Programmable Integrated Circuit”) 32 is fed via pins 5 and 14 with a voltage of 5 V coming from a source composed by a current-limiting capacitor J and a rectifier diode I, and a resistor F with a resistance around 10 000 Ohms. Moreover, the voltage of 5 V is provided by a filter capacitor H used for reducing the ripple tension (well-known term for the skilled man) and a Zener diode G, which fixates the desired voltage for feeding the PIC 32. In the present example, the diode G is for 5 V. The resistor F is connected with pin 4 of PIC 32. The excitation of coil 7 comes from pin 17 which circulates via tunnel or Gunn diode 39 and via the spark-gap 6, which activates the primary winding of a small transformer K, which generates and transmits the oscillation of the system to a tank circuit or LC circuit formed by a capacitor E and the primary coil 7. The purpose of the spark-gap 6 is to generate peaks of magnetic field by means of discharges (or, in practice, shortcircuits) of the capacitor E in coil 7. In practice, the spark-gap functions as an ON/OFF switch in the LC circuit. “Tank circuit” or LC circuit is the name given to a secondary oscillating circuit formed basically by a capacitor and by a coil, in the case above by coil 7 and capacitor E. The tunnel or Gunn diode 39 is inserted in the oscillator 4 as the third individual oscillation component, whose purpose is adding its frequency with the frequencies of the resonator 29 and the LC circuit of coil 7 and capacitor E. The insulating and elevating transformer K acts as an insulator between said LC circuit and the diode 39 together with resonator 29.

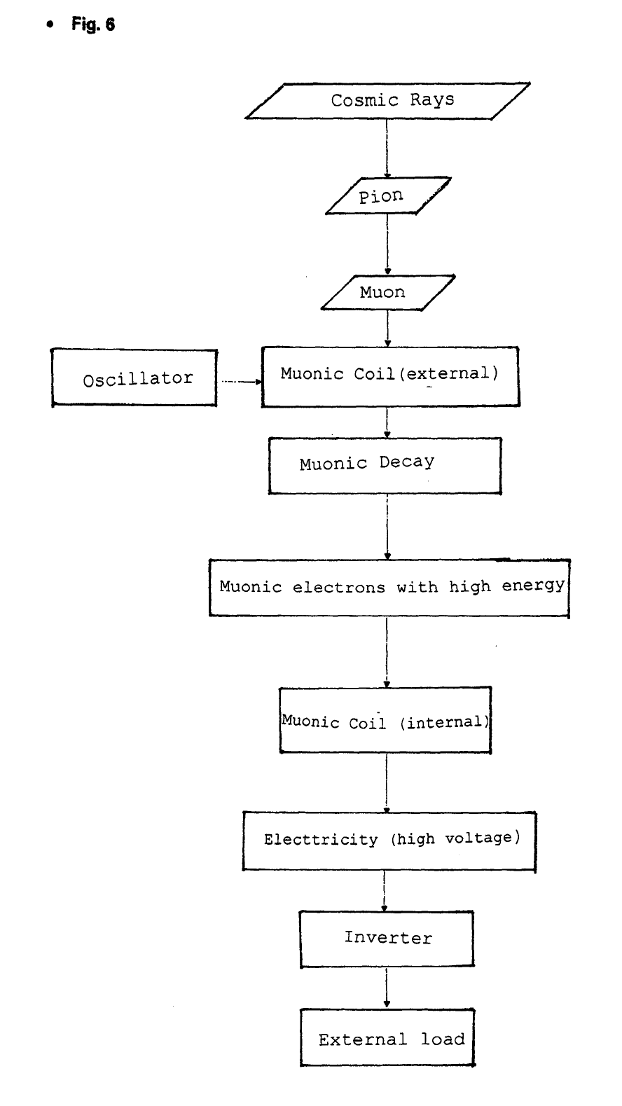

FIG. 6 shows the flowchart illustrating the physical process to capture and transform the decay of muons coming from the cosmic rays in electrical energy, by means of high-energy electrons coming from this decay. As shown in FIGS. 1 and 2, the process of the generation of electrical energy depends on the presence of muons coming from pions of primary cosmic rays. The muons are concentrated and directed by the magnetic field generated by an oscilating coil 7 that functions as an antenna, inside which the muons decay into muonic electrons of high energy. These electrons enter the wires of a second coil 13 located inside the first (7), resulting in electricity in the form of high voltage at its terminals. This high voltage is able to do work when applied appropriately to any external load.

As indicated above, it is an essential characteristic of the present invention that the oscillator 4 is tuned to the frequency of the wave function to capture the energy created by the decay of muons in the centre of the core 12 in relation to the above equation λ_{B}=n×λ_{C}=n×5.88×10⁻²³ m. Empirically it was established that λ_{B} should be around 5,88324456243×10⁻²³ m. This wavelength is obtained with great precision by way of a “chip” or integrated circuit PIC (“Programmable Integrated Circuit”), which is programmed to oscillate at exactly this wavelength. The programming of the integrated circuit is done by way of a PIC commercial programmer. Notwithstanding the illustrations and descriptions of the above patent, some modifications and alterations may occur to those skilled in this technique. It is noteworthy, therefore, that the claims described below are intended to encompass all possible modifications and alterations, including those resulting from associations or combinations of more than one device, which can arise from the present invention, without this changing its purpose.

### EXAMPLE 1

A commercial battery of 9 V and 0,1 A (therefore, of 0.9 W), which was connected to a device as in FIG. 1 with an outer coil 7 with a length of 25 cm and with a copper wire of 3 mm and a radius of 5 cm. The inner coil was also made of copper, with a wire of 5 mm and a radius of approximately 4 cm. A “chip” or integrated circuit PIC (32) (“Programmable Integrated Circuit”) is programmed to oscillate at wavelength λ_{B} above mentioned within the oscillator 4. Only as an example, one can use a Hartley type oscillator. The “PIC” 32 already pre-programmed to emit the λ_{B} above defined is inserted as in FIG. 5. The load utilized in this experiment consisted of 15 110 V 60 W bulbs, therefore a total charge of 900 W. Highly surprisingly, all the bulbs lit up with irradiance and normal brightness to the naked eye. This resulted in a COP of 1000, thanks to the capture of atmospheric muons.

### EXAMPLE 2

Once again in accordance with FIG. 1, in this example source 1 consisted of a home network of 110 V and 19 A. The power measured at exit 33, 34 was 40 000 V and 19 A. This means that the power increased by a factor of 380. This data is represented in Table 1 above. Obviously this surprisingly high increase is derived from the energy of the muonic electrons.

1. A muonic electromagnetic generator to be used for the generation of electrical energy, in which the generator is connectable to at least one source of electrical energy (1;2) with a power less than the power generated by the generator, wherein the generator comprises:
a) at least one outer electric coil;
b) at least one inner electric coil, situated substantially inside the outer electric coil
c) an oscillator;
the oscillator being tuned to the frequency at which the energy created by the decay of muons can be captured, and the oscillator being connected between the source of electric energy and the outer electric coil.

2. Generator in accordance with claim 1, wherein a spark-gap is connected in series with the oscillator between the outer electric coil and the oscillator.

3. Generator in accordance with claim 1, wherein a core or support of a non-conductive material is inserted inside the inner electric coil.

4. Generator in accordance with claim 1, wherein, the wavelength λ_{B} that corresponds to the frequency is around 5,88324456243×10⁻²³ m.

5. Generator in accordance with claim 4, wherein the wavelength is obtained with precision by way of a chip or integrated circuit PIC (Programmable Integrated Circuit) which is programmed to oscillate with exactly this wavelength and is inserted into the oscillator.

6. Generator in accordance with claim 1, wherein electrical energy with a power greater than the power of the source of electrical energy is generated in the inner electrical coil and conducted to feed any external load.

7. Generator in accordance with claim 6, wherein the external load is fed by way of an inverter with three-phase charge, usually after having been transformed to the voltage of use.

8. Generator in accordance with claim 1, wherein in inductive filter is inserted between the source of electric energy and the oscillator in order to protect the oscillator.

9. Generator in accordance with claim 1, wherein, when a source of electrical energy is direct current, an inverter, that transforms the direct current into alternating current, is introduced between the the source and the oscillator.

10. Process to generate electrical energy using an energy generator that is connectable to at least one source of electric power with a power less than the power generated by the process, wherein the process comprises:
a) to provide at least one outer electric coil
b) to provide at least on inner electric coil situated substantially inside the the outer electric coil;
c) to provide an oscillator that is connected between the the source electrical energy and the the outer electric coil;
d) to tune the oscillator to oscillate at the frequency of wave function to capture the energy created by the decay of muons, which are attracted to the magnetic field generated by the outer electric coil;
e) to direct the muonic electrons absorbed by the inner electric coil to any load.

11. The process in accordance with claim 10, wherein a spark-gap is inserted between the oscillator and the outer electric, coil.

12. The process in accordance with claim 10, wherein the oscillator is tuned to the frequency at which the energy can be captured which is created by the decay of muons, the wavelength λ^{B} that corresponds to the frequency being around 5,88324456243×10⁻²³ m.
